(19) United States
(12) Patent Application Publication
(10) Pub. No.: US 2018/0021609 A1
(43) Pub. Date: Jan. 25, 2018

(54) FIRE-FIGHTING DEVICE

(71) Applicants: THYSSENKRUPP MARINE SYSTEMS GMBH, Kiel (DE); thyssenkrupp AG, Essen (DE)

(72) Inventors: Rolf JÜRGENS, Hamburg (DE); Benjamin VOIGTLÄNDER, Hamburg (DE); Stephan BRINK, Hamburg (DE)

(73) Assignees: THYSSENKRUPP MARINE SYSTEMS GMBH, Kiel (DE); thyssenkrupp AG, Essen (DE)

(21) Appl. No.: 15/547,732

(22) PCT Filed: Jan. 7, 2016
(86) PCT No.: PCT/EP2016/050179

§ 371 Date: Jul. 31, 2017

(30) Foreign Application Priority Data
Feb. 5, 2015 (DE) 10 2015 202 033.9

(51) Int. Cl. A62C 2/08; F15D 1/10

(52) U.S. Cl. CPC A62C 2/08; F15D 1/10; A62C 3/10

(57) ABSTRACT

A fire-fighting device can cool a vertical wall where a horizontally-extending profiled element is disposed on the vertical wall. The fire-fighting device may comprise a guide plate that includes a first region arranged above the horizontally-extending profiled element, a second region arranged below the horizontally-extending profiled element, a third region arranged in a plane of the horizontally-extending profiled element and on a side of the horizontally-extending profiled element facing away from the vertical wall, and a fourth region in the second region. The guide plate may have a distance to the wall of 1 mm to 20 mm in the fourth region.

The invention relates to a fire-fighting device for a wall having a profiled element extending horizontally on the wall.

Many spaces nowadays comprise sprinkler systems for fire protection. Apart from direct fire fighting, a function of the sprinkler system is also that of cooling in order to fight a propagation of a fire. For this purpose, water is sprayed through the sprinkler system, for example against the walls or against the ceiling, in such a way that the water runs down the walls. The water which runs down cools the walls and thus prevents, through the cooling of the wall, the spread of a fire from a space situated on the other side of the wall. In addition, in the case of metal walls, the cooling ensures that the metal walls do not deform excessively in the heat and that, as a result, passages in particular remain passable.

However, if such a wall has a profiled element extending horizontally on the wall, the water flows down only as far as this profiled element on the wall and then on the profiled element away from the wall in the horizontal direction. The water then usually drips downward from the profiled element without further cooling the wall which is situated below the profiled element.

DE 2 339 352 A discloses a fire protection device for isolating spaces, comprising a liquid-permeable or liquid-absorbing shield, wherein the shield can be unrolled or unfolded.

U.S. Pat. No. 2,180,586 discloses a spray booth in which, for cleaning purposes, water is sprayed via a gap onto a vertical wall.

It is the object of the invention to provide an apparatus which allows areal wetting of a wall having a profiled element by means of a central sprinkler system.

The object is achieved by a fire-fighting device having the features specified in claim 1. Advantageous developments can be found in the subclaims, the following description and the drawing.

The fire-fighting device according to the invention for cooling a vertical wall comprises a guide plate. A horizontally extending profiled element is arranged on the vertical wall. The guide plate comprises at least one first region, which is arranged above the profiled element, at least one second region, which is arranged below the profiled element, and at least one third region, which is arranged in the plane of the profiled element and on the side of the profiled element facing away from the wall. The guide plate further comprises at least one fourth region in the at least one second region, wherein the guide plate has a distance to the wall of 1 mm to 20 mm in the at least one fourth region.

In the event of fire, the water which is sprayed by a sprinkler system would strike the wall above the profiled element and above the guide plate. From there, the water would run down the wall to the profiled element. On the profiled element, the water would first flow horizontally away from the wall on the profiled element. At the end of the profiled element, the water then flows down from the profiled element, with the water, on account of the flow velocity, describing a parabolic path in a first-order approximation. Here, the water strikes the second and third region of the guide plate and is thus guided back to the wall. By virtue of the comparatively narrow gap of 1 mm to 20 mm, the water does not pass further downward through the air, but is guided again onto the wall.

In a preferred embodiment, the guide plate has a distance to the wall of 2 mm to 10 mm in the at least one fourth region.

In a particularly preferred embodiment, the guide plate has a distance to the wall of 2.5 mm to 5 mm in the at least one fourth region.

In further embodiments, the distance between the at least one fourth region to the wall is 2 mm to 20 mm, 2.5 mm to 20 mm, 1 mm to 10 mm, 2.5 mm to 10 mm, 1 mm to 5 mm or 2 mm to 5 mm.

A distance of 20 mm should not be exceeded since otherwise the water can no longer be guided back efficiently onto the wall. The distance should furthermore not fall below a distance of 1 mm since otherwise the flow rate of water is very low.

In a further embodiment, the guide plate forms a closed area between the at least one first region and the at least one second region. As a result, the water is guided particularly efficiently back to the wall.

In a further embodiment, the guide plate consists of steel. This embodiment is particularly preferred if the wall and the profiled element also consist of steel. In addition, the guide plate must maintain its function particularly even in the case of a fire, for which reason plastics are less suitable. Stainless steels are particularly suitable. Examples of stainless steels are V2A and V4A.

In a further embodiment, the wall is a bulkhead. A bulkhead is a partition wall which may comprise openings, wherein the openings can be closed by lockable hatches. Bulkheads serve for example to prevent the propagation of fire or, in shipbuilding, the penetration of water.

In a further embodiment, the profiled element is a bead profile or a flat steel, preferably a bead profile. A bead profile is a flat steel profile having a thickening situated at the edge of a flat side. The thickening is situated on the side of the profiled element facing away from the wall. The thickening provides the profiled element with a reinforcement.

In a further embodiment, the guide plate is fastened to the profiled element. An advantage of this embodiment is that no fastening between wall and guide plate is required, which could have a negative effect on the use of the wall with water. The guide plate is preferably fastened to the profiled element by means of screws. However, other fastening methods are also conceivable, in particular riveting and welding.

In a further embodiment, the distance between the profiled element and the third region of the guide plate is preferably greater than the distance from the fourth region of the guide plate and the wall. As a result, the water is efficiency channeled round without the fire-fighting device constituting an unnecessary flow obstacle.

The fire-fighting device according to the invention is explained in more detail below with reference to an exemplary embodiment illustrated in the drawing.

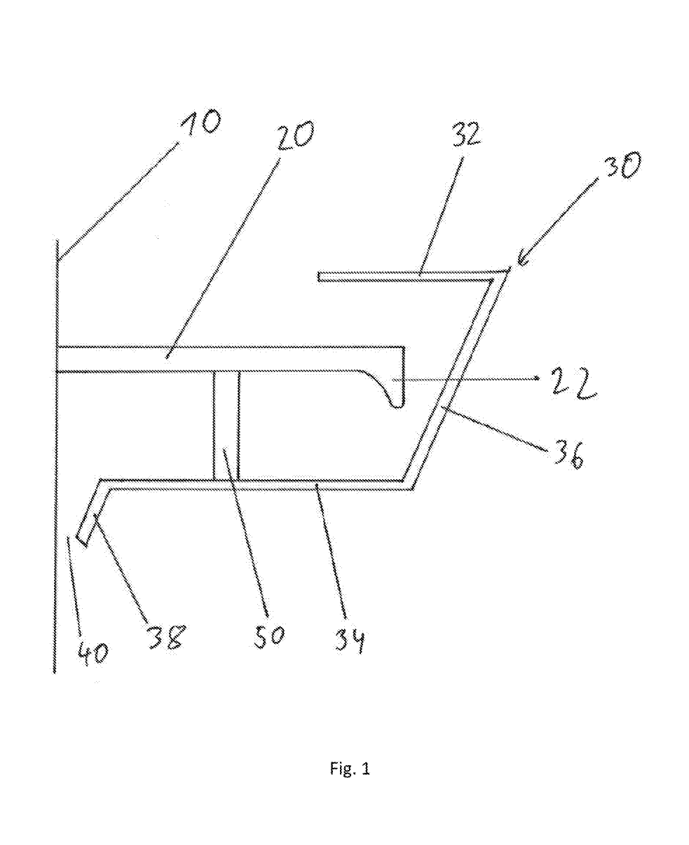

FIG. 1: Schematic illustration of a fire-fighting device according to the invention

In FIG. 1, the schematic design of a fire-fighting device according to the invention is illustrated. A profiled element 20 is arranged on a wall 10, the profiled element 20 being a bead profile. Therefore, the profiled element 20 has a thickening 22. A guide plate 30 is formed in such a way that water which flows down the wall 10 and is channeled away from the wall by the profiled element 20 is guided back again to the wall. For this purpose, the guide plate 30 comprises a first region 32, a second region 34 and a third region 36. These regions create a channel which receives water and guides it back to the wall 10. The second region 34 of the guide plate 30 comprises a fourth region 38 which forms a gap 40 with the wall 10. The guide plate 30 is connected to the profiled element 20 via a fastening 50.

For example, the profiled element 20 has a width of 60 mm, 80 mm, 100 mm or 120 mm and a thickness of 5 mm. The first region 32 preferably has a width of 35 mm, the third region a width of 55 mm. The distance defined by the fastening 50 between the profiled element 20 and the second region 34 of the guide plate 30 is preferably 25 mm. The gap 40 has a width of 1 mm to 20 mm, in the example shown a width of 5 mm. The distance between the profiled element 20 or the thickening 22 of the profiled element 20 and the third region 36 of the guide plate 30 is preferably greater than the distance from the fourth region 38 of the guide plate 30 and the wall 10. In the example shown, the distance between the profiled element 20 or the thickening 22 of the profiled element 20 and the third region 36 of the guide plate 30 is 7 mm.

### REFERENCE SIGNS

10 Wall

20 Profiled element

22 Thickening

30 Guide plate

32 First region

34 Second region

36 Third region

38 Fourth region

40 Gap

50 Fastening

1-8. (canceled)

9. A fire-fighting device for cooling a vertical wall wherein a horizontally-extending profiled element is disposed on the vertical wall, the fire-fighting device comprising a guide plate that includes a first region disposed above the horizontally-extending profiled element, a second region disposed below the horizontally-extending profiled element, a third region disposed in a plane of the horizontally-extending profiled element and on a side of the horizontally-extending profiled element facing away from the vertical wall, and a fourth region disposed in the second region, wherein in the fourth region the guide plate has a distance to the vertical wall of 1 mm to 20 mm.

10. The fire-fighting device of claim 9 wherein in the fourth region the guide plate has a distance to the vertical wall of 2 mm to 10 mm.

11. The fire-fighting device of claim 9 wherein in the fourth region the guide plate has a distance to the vertical wall of 2.5 mm to 5 mm.

12. The fire-fighting device of claim 9 wherein the guide plate forms a closed area between the first region and the second region.

13. The fire-fighting device of claim 9 wherein the guide plate comprises steel.

14. The fire-fighting device of claim 9 wherein the vertical wall is a bulkhead.

15. The fire-fighting device of claim 9 wherein the horizontally-extending profiled element is at least one of a bead profile or a flat steel.

16. The fire-fighting device of claim 9 wherein the guide plate is fastened to the horizontally-extending profiled element by screws.

17. A fire-fighting device for a vertical wall having a profiled element that extends generally horizontally from the vertical wall and that directs water that flows down the vertical wall away from the vertical wall, the fire-fighting device including a guide plate that comprises:
a first region disposed above the profiled element and extending generally horizontally;
a second region disposed below the profiled element and extending generally horizontally;
a third region connecting the first and second regions, wherein the third region is disposed outward of the profiled element relative to the vertical wall;
a fourth region that extends from the second region and is spaced apart from the vertical wall,
wherein the first, second, third, and fourth regions form a channel that redirects water that has been directed away from the vertical wall by the profiled element toward the vertical wall.

18. The fire-fighting device of claim 17 further comprising the profiled element that extends generally horizontally from the vertical wall.

19. The fire-fighting device of claim 17 wherein the fourth region of the guide plate is spaced apart 1 mm to 20 mm from the vertical wall.

20. The fire-fighting device of claim 17 wherein the fourth region of the guide plate is spaced apart 2 mm to 10 mm from the vertical wall.

21. The fire-fighting device of claim 17 wherein the fourth region of the guide plate is spaced apart 2.5 mm to 5 mm from the vertical wall.

22. The fire-fighting device of claim 17 wherein the guide plate is fastened to the profiled element by screws.

23. The fire-fighting device of claim 17 wherein a distance between the profiled element and the third region of the guide plate is greater than a distance from the fourth region of the guide plate to the vertical wall.
